(19) United States
(12) Patent Application Publication
(10) Pub. No.: US 2005/0003080 A1
(43) Pub. Date: Jan. 6, 2005

(54) Soil bonding composition and apparatus for and method of application

(76) Inventor: John Badera JR., Hartford, CT (US)

Correspondence Address: MCCORMICK, PAULDING & HUBER LLP, CITY PLACE II, 185 ASYLUM STREET, HARTFORD, CT, 06103, US

(21) Appl. No.: 10/882,825

(22) Filed: Jul. 1, 2004

Related U.S. Application Data
(60) Provisional application No. 60/484,482, filed on Jul. 2, 2003.

(51) Int. Cl. B05D 5/10; B05C 11/00

(52) U.S. Cl. 427/136; 427/421.1; 118/75

(57) ABSTRACT

A method of covering a surface with a matrix-forming polymer includes the step of applying a vinyl acrylic latex polymer to soil such that the polymer bonds particles of the soil to form a substantially continuous latex phase. A method of covering an earthen surface includes: preparing a soil layer; spraying a vinyl acrylic latex polymer on the soil layer such that the polymer bonds particles of the soil in a substantially continuous latex phase; and compacting the sprayed soil. A device for preparing soil for the application of a polymer to form a hardened surface includes rotatable tines and a distribution wand positioned proximate the tines. A mobile delivery system for dispensing a polymeric composition which when applied to soil creates a hardened surface includes containers having a polymer and a migrating agent stored respectively therein and a plurality of other associated trailer-mounted devices.

### CROSS-REFERENCE TO RELATED APPLICATION

The present application claims the benefits of U.S. Provisional Patent Application Ser. No. 60/484,482, filed Jul. 2, 2003, entitled DIRTGLUE, which is incorporated herein by reference in its entirety.

### TECHNICAL FIELD

The present invention relates generally to soil-bonding compositions and, more particularly, to a composition capable of bonding an indigenous soil to form a hardened surface, an apparatus for applying the composition, and a method of applying the composition.

### BACKGROUND OF THE INVENTION

Paving operations generally encompass laying down asphalt compositions using complex machinery. Because asphalt is an extremely viscous material, it must be maintained at an elevated temperature in the machinery and during its application. Not only does maintaining the asphalt at a high temperature significantly increase the energy costs of the paving process, the asphaltic compositions themselves contain bituminous materials that generate toxic vapors, particularly when heated, which pose potential health risks to individuals involved in paving processes.

In addition to having drawbacks with regard to energy costs and health concerns, paving processes are generally slow. Alternative methods of paving involve compositions that are clay-based and incorporate acrylic latex resins thus alleviating a portion of the energy costs and removing some of the health concerns. However, such methods are typically also slow due to the requirement that the clays used be a certain consistency and that the paving compositions be applied with complex machinery.

Furthermore, in applications of conventional as well as alternative paving compositions, the compositions themselves provide only a single function, namely, as a surface on which wheeled- or foot traffic can be sustained. Because of the nature of such compositions, they are oftentimes unsightly, unusable, and not complementary to a natural landscape. For example, in a landscaping application in which footpaths in a park are desired to be paved, given a choice of a less attractive pavement or an unpaved earthen surface, an authority responsible for making a decision may be more likely to opt for the less attractive pavement option, particularly when factors such as the pooling of water, the formation of mud, the formation of dust, and erosion are considered.

Another difficulty occurs wherein it is desirable to pave a remote location where the availability of conventional paving compositions is limited or non-existent. Even if the material were available it may be impossible to get the necessary equipment to the desired location.

Based on the foregoing, it is the general object of the present invention to provide a material, method, and apparatus for bonding soil that improves upon or overcomes the problems and drawbacks associated with the prior art.

### SUMMARY OF THE INVENTION

One aspect of the present invention is directed to a method of covering a surface with a matrix-forming polymer. The method includes the step of applying a vinyl acrylic latex polymer to soil such that the polymer bonds particles of the soil to form a substantially continuous latex phase. At undiluted and higher concentrations of the polymer, the substantially continuous latex phase maintains the soil particles in a closed matrix (i.e., substantially impenetrable) to provide a surface on which traffic can be sustained. When diluted to lower concentrations, the polymer provides a substantially continuous latex phase that maintains the soil particles in an open matrix (i.e., penetrable) through which liquid can flow and through which small objects can migrate.

Another aspect of the present invention is directed to a method of covering an earthen surface. Such a method includes: preparing a soil layer of the earthen surface; spraying a vinyl acrylic latex polymer on the prepared soil layer such that the polymer bonds particles of the soil in a substantially continuous latex phase; and compacting the prepared and sprayed soil. Preparation of the soil may include tilling or grading the soil or a combination of both. Compaction of the soil is generally effected by rolling a weighted cylinder over the soil although other methods such as tamping can be used.

Another aspect of the present invention is directed to a device for preparing soil for the application of a polymer to form a hardened surface. In this aspect the device comprises rotatable tines and a distribution wand positioned proximate the tines. The tines are preferably mounted so as to extend radially from an axially-rotatable driveshaft, and the distribution wand is configured to dispense the polymer as the tines operate to prepare the soil. In tilling the soil, the rotating motion of the driveshaft causes the tines to dig into the soil and turn the soil over.

Yet another aspect of the present invention is directed to a mobile delivery system for dispensing a polymeric composition which when applied to soil creates a hardened surface. Such a system includes a first container having a vinyl acrylic latex polymer stored therein; a second container having a migrating agent stored therein; a mixer in fluid communication with the first and second containers for blending the polymer and the migrating agent together to create a mixture, the mixer including means for adjusting the ratio of polymer to migrating agent; dispensing means for transferring the mixture out of the mixer; and a generator for supplying power to operate the mixer. The first and second containers, the mixer, the dispensing means, and the generator are mounted on a trailer.

One advantage to the methods as described above is the ease of application of a material to form a paved surface that is capable of sustaining traffic, controlling dust, and/or limiting erosion after a short period of time. In contrast to conventional paving methods, the above methods provide a quick-cure coating that can be used for civilian or military applications in as little as two hours. Also, the amount of equipment needed to apply such a coating is typically far less complex and costly than the equipment used in conventional paving applications (sprayers and tanks as opposed to heated asphalt paving machinery).

Another advantage is an improved aesthetic quality of the applied polymer. The cured polymer, when bonded to soil, is unobtrusive and does not detract from the existing landscape. Thus, both the look and integrity of the natural landscape is preserved. Furthermore, the polymer can be dyed to match or blend into the natural landscape.

Still another advantage is the non-toxicity of the polymer itself. Because the polymer is a water-emulsified acrylic resin, the finished application of the polymer is environmentally-friendly. Furthermore, because it is supported in a latex phase, it can be cleaned up using soap and water.

### BRIEF DESCRIPTION OF THE DRAWINGS

FIG. 1 is a perspective view of a leveling-barrel arrangement from which a polymer can be applied to soil.

FIG. 2 is a perspective view of a tilling device of the present invention used to prepare soil for application of the polymer.

FIG. 3 is a perspective view of a trailer of the present invention for transporting tanks containing the polymer.

### DETAILED DESCRIPTION OF THE PREFERRED EMBODIMENT

Disclosed herein is a polymer for use in covering an earthen surface, an apparatus for applying the polymer, and a method for applying the polymer. When applied, the polymer bonds soil into a hardened surface that is watertight, resilient, resistant to insects, resistant to water and wind erosion, and sufficiently durable to sustain traffic. Preferably, the soil used is indigenous to the area at which the paving application occurs. If, however, indigenous soils are not desirable, other soils can be imported for the application and used with the polymer. As used herein, the term “indigenous” means occurring naturally in a particular environment or region. As used herein, the term “soil” means dirt, dust, rocks, gravel, stones, sand, clay or any combination of the foregoing materials. Although the apparatuses and methods described herein refer to paving applications, it should be understood that the apparatuses and methods are also applicable to non-paving applications (e.g., for dust control, re-vegetation, etc.)

In one embodiment, the polymer is a vinyl acrylic latex material containing about 40 weight percent (wt. %) or more solids in a water and/or alcohol base. As is used herein, the term “latex” means an aqueous suspension of hydrocarbonaceous polymer. The polymer may also contain up to about 0.1 wt. % residual monomers (e.g., emulsifying agents) and up to about 0.04 wt. % aqueous ammonia (as a preserving agent). The balance is water and/or alcohol. Use and storage of the polymer at temperatures of more than about 45 degrees Fahrenheit (F) results in a more preferable application. Also, the polymer provides a superior bond with soil particles when the soil contains less than about 1 wt. % salt.

The polymer may be used straight or in diluted form depending upon the application. When applied to soil, the polymer cures around particles of soil to form a substantially continuous latex phase. As used herein, the term “substantially continuous latex phase” means a phase that binds to itself and particles of soil such that the formation of aggregate portions of soil is minimized. A migrating agent for diluting the polymer preferably comprises about 2 wt. % to about 5 wt. % polymer in water.

When the polymer is used in an undiluted- or moderately diluted form, it cures to provide a closed matrix system that is useful for paving, dust suppression, weed control, and anti-erosion applications. For example, for paving applications that support heavy road traffic the polymer is preferably used undiluted. In conditions supporting moderate road traffic, the polymer may be diluted down to about a one to 2.5 ratio (1:2.5) (volume/volume). For conditions that support a degree of traffic between moderate and heavy, the polymer may be diluted accordingly. Conditions indicative of moderate- to heavy road traffic include, but are not limited to, highway and road use, parking lots, airport runways and taxiways, and the like.

For dilutions of about 1:2.5 to about 1:7.5, the resulting cured polymer provides a matrix that may be open or closed depending upon the soil conditions. Polymers cured in this range are particularly useful for the paving of light-wheeled traffic paths and foot paths. At higher concentrations (about 1:2.5), the polymer is capable of supporting the light auto traffic that is characteristic of dirt roads, driveways, firebreaks, utility paths, right-of-ways, and the like. At lower concentrations (about 1:7.5), the polymer is capable of supporting light wheeled traffic such as golf carts, bicycles, skates, and the like as well as foot traffic. Products comprising polymer diluted to about 1:7.5 are well-suited for surfaces that require sufficient hardness to support light wheeled traffic and yet are flexible or resilient to such an extent that injury is reduced or limited upon a person falling on the surface.

The formation of mud can also be controlled when the polymer is diluted to about 1:5. When used for mud control, the polymer is applied to and tilled, injected, or otherwise dispersed into the soil when the ground is dry.

When the polymer is diluted to about 1:7.5 or greater, it cures to provide an open matrix system that is capable of allowing migration therethrough. An open matrix system that is capable of allowing migration therethrough is useful for re-vegetation, re-forestation, and landscaping applications. When used at this dilution, a soil aggregated by the polymer allows for the penetration of water, thereby allowing plant growth to occur within the open matrix while limiting the amount of erosion.

A preferred method of utilizing the polymer for a paving application includes applying the polymer directly to a soil. The application of the polymer may be by spray using pressurized gas, by spray or dispersion of droplets under head pressure of the polymer itself, or by any other suitable method. For most applications, sufficient fluid head is provided in a large tank of the polymer to effect the suitable dispersion of the polymer through a nozzle or similar outlet device without pressurizing gases.

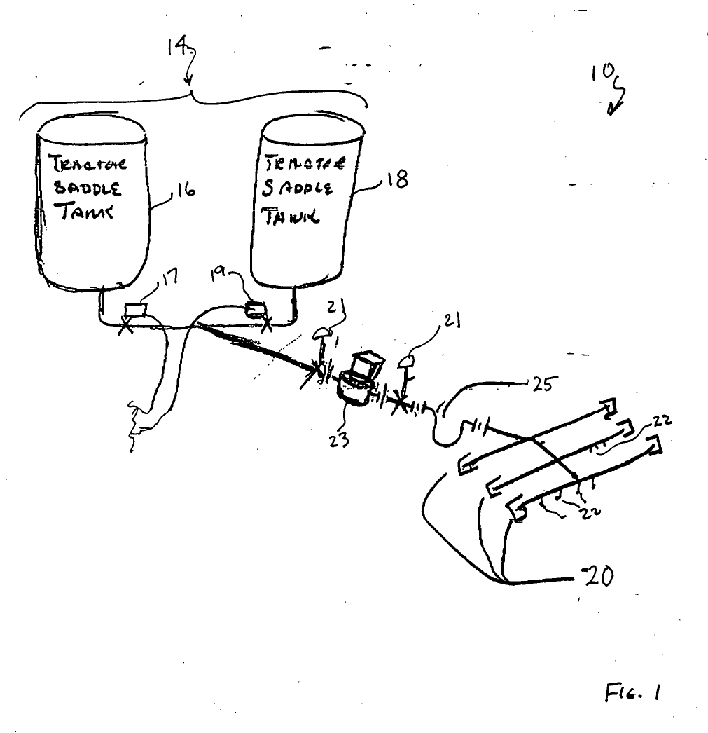

The application of the polymer (i.e., the polymer in either an undiluted- or diluted form) can be effected using any one or a combination of systems. Referring now to FIG. 1, one embodiment of such a system (shown generally at 10) is used in conjunction with a tractor that is typically utilized for agriculture purposes. The tractor preferably has a combination leveling-barrel arrangement 14 comprising a first tank 16 and a second tank 18 mounted in a saddle configuration. Each tank is preferably in fluid communication with the other to allow polymer to be drawn from both such that the weight of the polymer is evenly distributed on the tractor. A first outlet line from the first tank 16 includes an electric solenoid valve 17 that is connected to the transmission of the tractor and to a fuel cut-off switch. A second outlet line from the second tank 18 includes a similar electric solenoid valve 19 that is also connected to and the transmission of the tractor and to the fuel cut-off switch. Both outlet lines include plumbing (e.g., valves 21, pumps 23, and the like) to allow the polymer to be transferred to one or more distribution wands 20. The valves 21 may be manually operable or automatic. The pump 23 is preferably an adjustable hydraulic diaphragm pump that operates at a maximum pressure of 45 pounds per square inch gauge (psig). Flexible hosing 25 may be used in the system 10 to provide fluid communication to the distribution wands 20. The distribution wands 20 may be adjustable to control the amount of polymer dispensed and applied to the soil. Adjustable spray nozzles 22 on the distribution bar 20 allow for the most effective allocation of polymer. The system 10 may be used with or without a tilling device.

The method may also include preparing the soil in a suitable manner to break up agglomerations of the soil to facilitate soil/polymer contact upon application of the polymer. Preparation of the soil may include a combination of various techniques. One particular manner of preparing the soil includes tilling the soil to break up aggregated material such as clays or the like. Another manner of preparing the soil includes grading the soil prior to or in place of tilling. The application of the polymer to the soil also preferably includes compacting the soil after any grading and/or tilling and after applying the polymer.

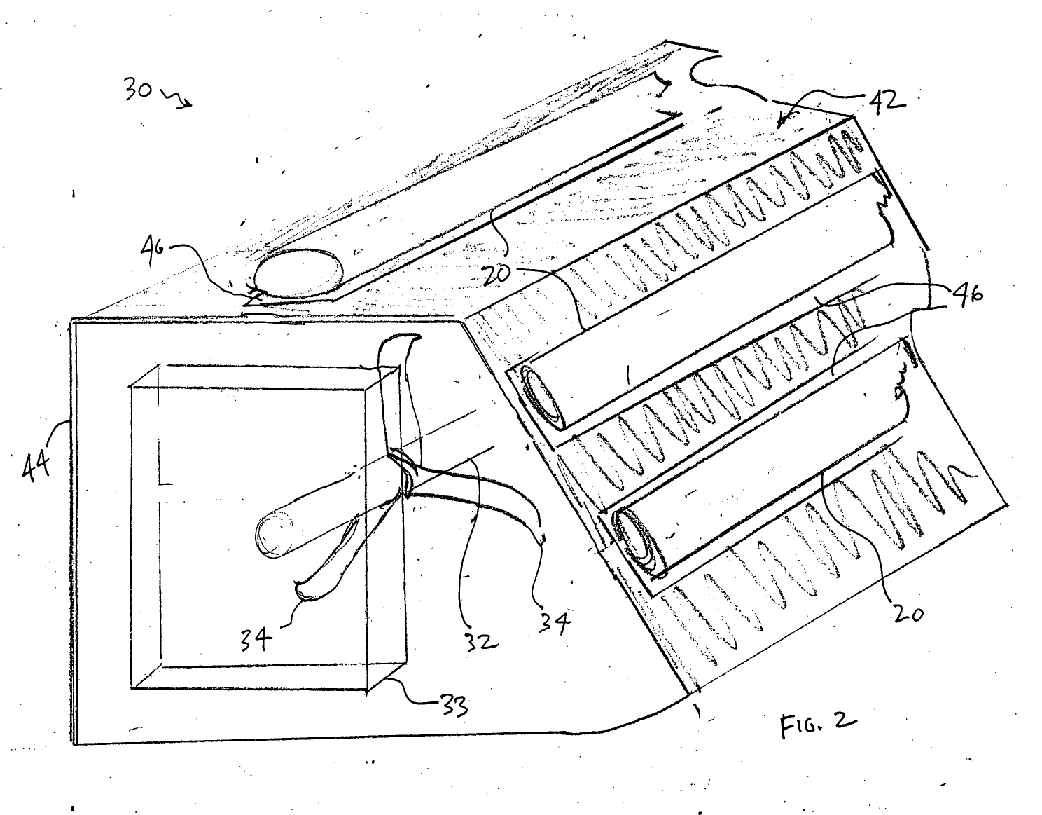

Referring now to FIG. 2, one embodiment of an apparatus for preparing the soil comprises a tilling device, which is shown generally at 30. The tractor as described above (or a separate vehicle) may be fitted to include the tilling device 30. Preferably, the tilling device 30 comprises a driveshaft 32, which is oriented to be parallel with the ground surface and axially rotatable via a drive mechanism 33, and which includes a plurality of tines 34 that dig into the soil when the driveshaft 32 is rotated. The tines 34 extend radially outward from the driveshaft 32 and are preferably arranged in clusters of three, each cluster being spaced along the length of the driveshaft 32. The ends of the tines 34 are bent such that upon rotation of the driveshaft 32, the tines 34 break up chunks of soil and turn the soil over.

The polymer is applied through the distribution wand 20 that is positioned parallel to the driveshaft 32 and is positioned in front of, directly above, or behind the tines 34. Preferably, multiple distribution wands 20 are positioned relative to the driveshaft 32 (e.g., one in front of, one directly above, and one behind the tines 34). A shroud 42 is preferably attached to a frame 44 of the device 30 to deflect any rocks that may become loose and thrown upon tilling the soil. Openings 46 in the shroud 42 allow the polymer to flow (e.g., drip or be sprayed) through the shroud 42 and onto or near the tines 34. Additional shrouds, sections of driveshaft, sections of distribution wands, and tines can be attached together, thereby making the tilling device adjustable in width for various applications. Walk-behind tillers having tanks for holding the polymer can be used for small (e.g., residential) applications.

Compaction of the soil after preparation and spraying preferably includes rolling the soil with a weighted rolling device. In typical applications, compaction facilitates the bonding of the polymer to soil particles. For example, after compaction light automobile use can be sustained after about two hours, and light to heavy traffic can be sustained after about 24 hours. A full cure is effected after about 30 days.

In another embodiment, soil and the polymer may be mixed in a mixing machine and spread using techniques comparable to techniques used to spread concrete, bituminous concrete, or asphalt. In such an embodiment, the spreading of the soil/polymer mix may be over rebar or a similar net-like support structure. Preferably, the soil/polymer mix is compacted after being spread.

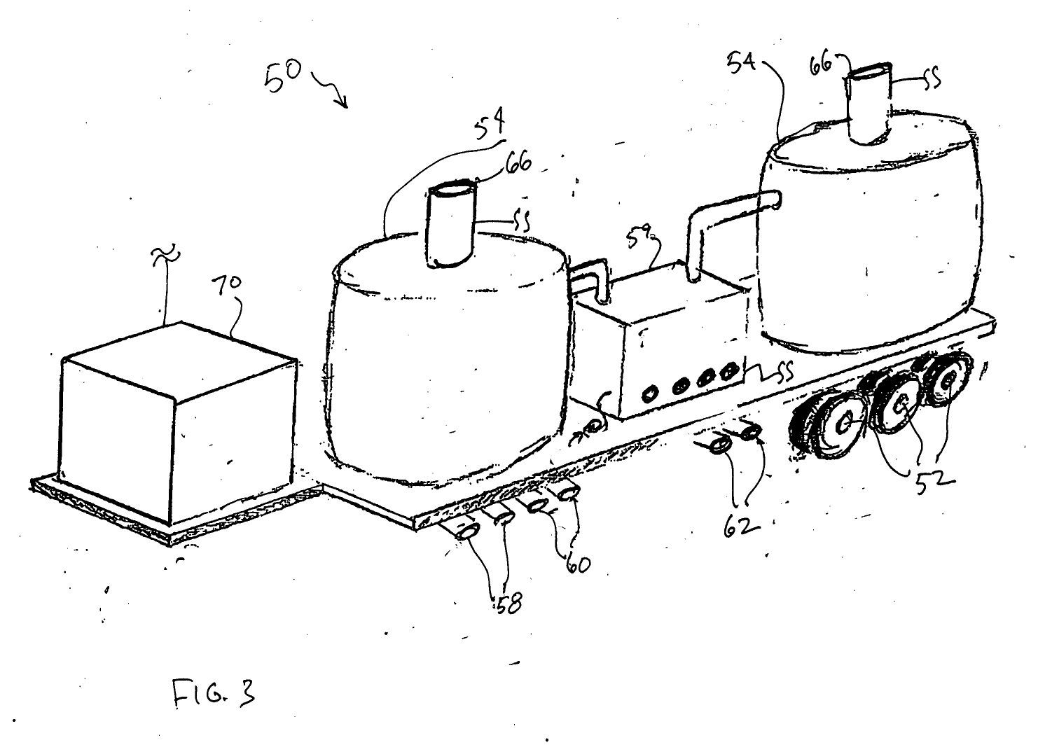

The polymer can be transported and distributed via a wheeled trailer or a marine tanker vessel properly sealed to prevent seawater from leaking into the tank holding the polymer. Such trailers or tankers may include separate containers, compartments, or tanks that contain the polymer and the migrating agent as well as hoses, valves, and pumps. Referring now to FIG. 3, one type of wheeled trailer that may be used may be a low-boy trailer 50 having multiple axles 52 and including two or more tanks 54 for holding polymers and (optionally) migrating agents, the wheels providing mobility to the trailer 50. The tanks 54 may be charged through openings at the tops of the tanks 54, or they may be charged through polymer intake ports 60 and (optionally) migrating agent intake ports 62. The agitation of the polymer is via agitators 66 and is computer-controlled. The polymer is distributed directly from the tanks 54 through outlet ports 58 via a mixer such as a pump/valve arrangement 59. The mixing of the polymer and the migrating agent is also computer-controlled (e.g., the amounts of polymer and migrating agent dispensed through the pump/valve arrangement is controlled by a computer in response to the desired finished composition). Also, devices associated with the trailer 50 may provide for the analysis of the soil materials (e.g., particle size, moisture content, salt content) and provide an output that recommends a particular dilution level. A generator 70 may supply power to the agitators 66 as well as any other device located on the trailer 50.

The tanks 54 may also be heated or cooled, for example by circulating steam or coolant through a coil positioned inside or outside the walls of the tanks 54. Heating the polymer and migrating agents facilitates the application of the polymer in climates subject to extreme temperatures. For example, in extremely cold climates the tanks 54 are preferably heated to prevent the water and/or alcohol base from freezing as well as to provide an optimum temperature for the bonding of the polymer to itself and to soil. In extremely hot climates the tanks 54 are preferably cooled to provide a more conducive environment for application of the polymer.

Application of the polymer for purposes of dust control or erosion prevention comprises spraying the undiluted or diluted polymer directly onto earthen surfaces. Once applied, the polymer binds with particles of soil and encapsulates the particles. By binding with the particles of soil, particle size and mass is increased, thus reducing the opportunity for the finer particles of the soil to be dispersed as dust. The spraying of large expanses of land to control dust is especially desirable with regard to military applications, particularly because of the adverse affects dust and sand have on military equipment. Furthermore, the control of dust at bivouac sites, battle staging areas, motor pools, ammo dumps, airfields and helicopter landing sites allows military personnel to operate in an environment that is cleaner than that in which the ground is untreated.

Additionally, the application of the polymer sufficiently hardens the ground surface such that the planting of mines is made difficult if not impossible. Also, hardened ground surfaces provide for a more stable support base for mortar- and artillery sites. Hardened routes can also provide for quick and stable movement of heavy equipment (e.g., tanks, artillery, personnel carriers) as well as logistical operations (e.g., the transport of fuel, food, and other supplies) by truck.

For purposes of preventing erosion, application of the polymer to an earthen surface stabilizes the ground in preparation for building or transportation projects. Soil bases under and around building pads (including tool shed pads, garages, barns, and the like), foundations, footings, landfills, and other infrastructure can be supplemented with the polymer to provide stability to constructions. In earthquake-prone areas, the polymer can be injected into the soil where it will wick into the more porous elements of the soil and into crevices and harden, thus strengthening the ground. The polymer can be used in an undiluted or diluted form as a road base or as a road itself, as a stabilizing base for railroad beds, for the repair of existing paved surfaces, or as a material for maintaining shoulders, dirt roads, service roads, logging trails, and the like.

Application of the polymer to a ground surface and binding of soil particles furthermore allows better drainage of the soil to be realized. After application at a dilution that promotes a closed matrix bond, rainwater is inhibited from contacting the soil and can be subsequently directed away from water-sensitive equipment. Levies, berms, sand dunes, and earthen dams can be maintained with the polymer to prevent erosion, which can aid in the control of flood waters. Areas prone to mud slides can also be sprayed to harden the exposed soil and to prevent or inhibit mud flow, thereby making remediation efforts easier and less costly. Areas prone to wind erosion (e.g., sand areas in and around golf courses in windy climates) can also be treated to preserve natural landscapes.

The areas surrounding ponds and lakes can also be treated to limit the natural erosion of the banks thereof. The banks of streams and rivers can be treated to direct the flow of water to protect structures that would otherwise be at risk from the flow, particularly when the flow is increased due to water runoff from heavy rains or snows. Potentially developable land that would otherwise be unusable can be reclaimed and used for agricultural, commercial, or residential purposes.

The polymer is also applicable to a variety of animal-related purposes. For example, the polymer can be used to stabilize earthen floors of barns, paddocks, stalls, horse trails, cow paths, animal feeding- and watering areas, storage areas, and the like.

Application of the polymer to a deforested area will allow an area to re-vegetate. For example, a light spray of the diluted polymer in areas deforested by fire will eliminate or inhibit erosion. Also, the applied polymer inhibits insect infestation without toxicity to humans or animals. The polymer can be sprayed from the ground using spraying apparatuses, or it can be sprayed or otherwise dispersed from the air using aircraft.

The polymer can be used as a building component or as a landscaping compound (e.g., as an alternative to or a supplementation to conventional mulch). Bricks, pavers, cobbles, artificial stream beds, pond beds, and the like can be fabricated using the polymer and an optional base component (e.g., cellulose, wood chips, wood fibers, paper, ground- or shredded waste rubber materials, ground- or shredded recycled plastic materials, and the like). When the polymer is combined with the optional base component and made sufficiently fluid, it can be sprayed, dabbed, rolled, or otherwise applied to a sub-structure to provide a wall. In one embodiment, the material can be applied to a wooden, concrete, or metal frame structure across which an anchoring material (e.g., chicken-wire) is stretched and attached. When used as a building material in extreme environments (e.g., in environments that are drier, hotter, and more sunny than average), subsequent re-applications of the polymer is recommended.

The polymer can also be used in sub-surface applications. In mining operations, for example, the polymer can be used to provide stability to mine walls and floors, as well as to provide hardened surfaces for the channeling of water in an effort to avoid pooling, which may have adverse effects on ground stability. In open mining operations, the polymer may be used to stabilize banks and/or to provide erosion- and dust control. Tailing dumps can be capped or encased with the polymer to stabilize and provide erosion- and dust control.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A method of covering a surface with a matrix-forming polymer, comprising the step of:
applying a vinyl acrylic latex polymer to soil such that said polymer bonds particles of said soil in a substantially continuous latex phase.

2. The method of claim 1, wherein applying said polymer comprises spraying said polymer using pressurizing gas onto said soil.

3. The method of claim 1, wherein applying said polymer comprises dispersing said polymer through a nozzle structure using the pressure head of the polymer.

4. The method of claim 1, further comprising preparing said soil to facilitate soil/polymer contact upon application of said polymer.

5. The method of claim 4, wherein preparing said soil comprises tilling said soil to break up aggregated materials in said soil.

6. The method of claim 4, wherein preparing said soil comprises grading said soil prior to applying said polymer.

7. The method of claim 1, further comprising compacting said soil after applying said polymer.

8. The method of claim 1, further comprising diluting said polymer with a migrating agent.

9. The method of claim 8, wherein said polymer is diluted to about 1:2.5 (volume/volume) with said migrating agent, said diluted polymer being suitable for paving a surface capable of sustaining moderate to heavy traffic.

10. The method of claim 8, wherein said polymer is diluted to about 1:2.5 (volume/volume) to about 1:7.5 (volume/volume) with said migrating agent, said diluted polymer being suitable for paving a surface capable of sustaining light wheeled traffic and foot traffic.

11. The method of claim 8, wherein said polymer is diluted to about 1:7.5 (volume/volume) or greater with said migrating agent, said diluted polymer being suitable for application to a surface capable of sustaining plant growth.

12. The method of claim 1, wherein said soil is indigenous to an area at which the earthen surface is being paved.

13. The method of claim 1, wherein said vinyl acrylic latex polymer contains about 40 wt. % or more solids in a water base.

14. A method of covering an earthen surface, comprising the steps of:
preparing a soil layer of the earthen surface to facilitate de-agglomeration of soil particles;
spraying a vinyl acrylic latex polymer on the prepared soil layer such that said polymer bonds particles of soil in a substantially continuous latex phase; and
compacting said prepared and sprayed soil.

15. The method of claim 14, wherein the step of preparing said soil layer comprises grading said soil layer.

16. The method of claim 14, wherein the step of preparing said soil layer comprises tilling said soil layer.

17. The method of claim 14, wherein said polymer contains about 40 wt. % or more solids in a water base.

18. The method of claim 17, further comprising diluting said polymer.

19. The method of claim 18, wherein said polymer is diluted to less than about 1:2.5 with a migrating agent.

20. The method of claim 18, wherein said polymer is diluted to about 1:2.5 to about 1:7.5 with a migrating agent.

21. The method of claim 18, wherein said polymer is diluted to about 1:7.5 or greater with a migrating agent.

22. A device for preparing soil for the application of a polymer, said device comprising:
a plurality of rotatable tines; and
at least one distribution wand positioned proximate said tines, said distribution wand being configured to dispense said polymer as said tines operate to prepare the soil.

23. The device of claim 22, wherein said tines extend radially from an axially-rotatable driveshaft.

24. The device of claim 22, wherein said distribution wand extends parallel to an axially-rotatable driveshaft to which said tines are attached.

25. The device of claim 22, further comprising a shroud mounted to a frame of said device, said shroud being positioned over said tines and having openings through which said polymer can flow to be disposed on said soil.

26. The device of claim 22, wherein said device is adjustable in width.

27. A mobile delivery system for dispensing a polymeric composition which when applied to soil creates a hardened surface, comprising:
a first container having a vinyl acrylic latex polymer stored therein;
a second container having a migrating agent stored therein;
a mixer in fluid communication with said first and said second containers for blending said polymer and said migrating agent together to create a mixture, said mixer including means for adjusting the ratio of polymer to migrating agent;
dispensing means for transferring said mixture out of said mixer;
a generator for supplying power to operate said mixer; and
wherein said first and second containers, said mixer, said dispensing means, and said generator are mounted on a trailer.

28. The system of claim 27, further comprising a first agitator on said first tank and a second agitator on said second tank.

29. The system of claim 27, wherein said dispensing means comprises an outlet port through which said mixture can be received.

30. The system of claim 27, further comprising polymer intake ports through which said polymer can be charged to said first container and migrating agent intake ports through which said migrating agent can be charged to said second container.
